(19) United States
(12) Patent Application Publication
(10) Pub. No.: US 2005/0015158 A1
(43) Pub. Date: Jan. 20, 2005

(54) Data acquisition system and method for process control and recording medium with recorded data acquisition program

(76) Inventor: Kyung-Yang Min, Seoul (KR)

Correspondence Address: MORGAN & FINNEGAN, L.L.P., 3 WORLD FINANCIAL CENTER, NEW YORK, NY, 10281-2101, US

(21) Appl. No.: 10/874,072

(22) Filed: Jun. 22, 2004

(30) Foreign Application Priority Data
Jul. 16, 2003 (KR) 2003-48899

(51) Int. Cl. G05B 15/00; G05B 11/01; G05B 19/42

(52) U.S. Cl. 700/1; 700/17

(57) ABSTRACT

There are provided a data acquisition system and method for process control in which data can be automatically acquired using a data acquisition program, and a recording medium storing the data acquisition, wherein the data acquisition program for implementing the data acquisition system and method has basic control units for each process for supporting respective measuring equipments, and a hierarchical structure comprising the basic control units, sequentially executing the processes, and allowing mutual control among the processes, whereby the development time can be remarkably reduced to allow efficient design and development of a system and the development cost can be also reduced.

### BACKGROUND OF THE INVENTION

1. Field of the Invention

The present invention relates to a data acquisition system and method for process control and a recording medium with a recorded data acquisition program. More particularly, the present invention relates to a data acquisition system and method for process control, in which data can be automatically acquired using a data acquisition program, which comprises basic control units by processes supporting respective measuring equipments and a hierarchical structure comprising the basic control units, sequentially executing the processes, and enabling mutual controls of the processes, and a recording medium on which the data acquisition program is recorded.

2. Description of the Related Art

In general, data acquisition programs, which are software supporting measuring equipments, are approximately classified into a first generation DAQ (Data AcQuisition) and a second generation DAQ.

In the first generation DAQ, data are acquired using programs prepared in text-based languages such as C, Pascal, Basic, etc. The first generation DAQ has an advantage that users can best express their needs, but also has disadvantages that high cost and much labor should be spent. That is, in order to acquire data, since users should be fully aware of general programming languages, know overall details such as interfaces with the measuring equipments, data formats, etc., create graphical user interfaces (GUI) corresponding to their own purposes and classes by using technologies such as object-oriented programming (OOP), and construct event handlers, the first generation DAQ has disadvantages that it is difficult for a skilled developer to develop the first generation DAQ and much time should be taken.

On the other hand, the second generation DAQ grew rapidly using graphical languages with advent of Window 3.1 and includes products such as Labview and Agilent VEE. However, the second generation DAQ provides only development environments, not final solutions, similarly to the first generation DAQ.

Then, a concept of object representing keywords or classes of compilers has been introduced to the second generation DAQ, so that the objects could be connected with lines to prepare programs.

However, since the number of objects is increased every version and input and output points to be connected with lines should be provided every object, the second generation DAQ also has a disadvantage that users should connect the lines and points to complete the development.

In addition, since it is hard to construct loops including instructions such as “for”, “while”, etc. and completed source codes, that is, graphical codes, has a spaghetti format, the second generation DAQ also has a disadvantage that debugging thereof is very difficult.

Since LabView by National Instruments Corporation currently having the largest market share in the field of measuring equipments is a graphical language as the second generation DAQ, not a software solution, users should fully take charge of development and test of the software. Further, since LabView has 600 or more graphical objects and each object has 10 I/O terminals as average, users should handle 6000 or more I/O terminals. Therefore, since it takes very much time for an expert in the field to identify the I/O terminals, it takes several months to develop programs for relatively-simple measuring equipments. Specifically, the second generation DAQ also has a problem that burdens of development which is imposed on users due to considerably many upgrades and addition of functions have not been decreased since the early 1980s when LabView came to the market.

That is, since general-purpose and open software systematically controlling processes using measuring equipments is not developed yet and only special-purpose software supporting special equipments or tools of a function unit type and development environments thereof helping development by equipments are provided, users have required development of the general-purpose and open software systematically controlling the processes using the measuring equipments.

### SUMMARY OF THE INVENTION

Therefore, the present invention is contrived in response to the above requirement for development and it is an object of the present invention to provide a data acquisition system and a data acquisition method for process control in which data can be automatically acquired using a data acquisition program which comprises basic control units by processes supporting respective measuring equipments and a hierarchical structure comprising the basic control units, sequentially executing the processes, and enabling mutual controls of the processes, and a recording medium on which the data acquisition program is recorded.

It is also an object of the present invention to provide a data acquisition system and a data acquisition method for process control in which a user can control all measuring equipments and plug-in cards without preparing another program by providing intuitive user interfaces, generality, and openness, and a recording medium on which a data acquisition program is recorded.

It is another object of the present invention to provide a data acquisition system and a data acquisition method for process control in which data measured in different formats by measuring equipments can be automatically recognized to secure generality by providing basic control units for controlling single processes, and a recording medium on which a data acquisition program is recorded.

It is another object of the present invention to provide a data acquisition system and a data acquisition method for process control in which user/vendor-defined programs can be combined to secure openness, a user's intention can be translated into a flowchart, and thus all the processes other than a user's simple input can be automated by providing other function units such as plotting, etc., and a recording medium on which a data acquisition program is recorded.

It is another object of the present invention to provide a data acquisition system and a data acquisition method for process control which have a function of systematically controlling complex processes and sequentially executing basic control units in accordance with conditions determined by a plan of a user-defined execution order and data values being dynamically varied, and a recording medium on which a data acquisition program is recorded.

It is still another object of the present invention to provide a data acquisition system and a data acquisition method for process control in which global control parameters generated in basic control units are called out, whereby real-time mutual control of processes and exchange of software triggering signals are possible by means of cross-reference, and a recording medium on which a data acquisition program is recorded.

It is still another object of the present invention to provide a data acquisition system and a data acquisition method for process control in which a user interface is provided in a flowchart format in a structure to allow software for controlling processes with measuring equipments or plug-in cards to satisfy six basic conditions, that is, generality, openness, extensible data packing, real-time controllability, intuitive property and flexibility of interface, and scalability, and a recording medium on which a data acquisition program is recorded.

It is still another object of the present invention to provide a data acquisition system and a data acquisition method for process control, in which mutual control between processes and software triggering are allowed by extending a control function in a single process in a case of controlling two or more processes, and in which another generic structure of synchronizing and sequentially executing the processes is provided, and a recording medium on which a data acquisition program is recorded.

It is still another object of the present invention to provide a data acquisition system and a data acquisition method for process control, in which a solution not requiring a user's programming can be prepared by installing all programs relative to a whole control other than a user's simple input required for setting predetermined equipments, preparing a feedback routine and preparing an execution order of processes, and a recording medium on which a data acquisition program is recorded.

It is still another object of the present invention to provide a data acquisition system and a data acquisition method for process control, which support arrangement and analysis of data measured by measuring equipments by applying a customer relationship management (CRM) method representing methodology or software for allowing a company to manage customer relationships to the measuring equipments, and a recording medium on which a data acquisition program is recorded.

In order to accomplish the above objects, according to an aspect of the present invention, there is provided a data acquisition system for process control, the system comprising: one or more task modules comprising an editor module for transmitting a control command which is set by a user and is input to each measuring equipment in accordance with a communication protocol, a measuring module for storing the communication protocol, a filter module for identifying a format of data detected by the measuring equipments and automatically recognizing the data in response to the control command transmitted in accordance with the communication protocol stored in the measuring module, a feedback module for generating a user-defined control routine and generating user-defined data by using the recognized data, and a branch module for processing conditional statements or loop statements in response to the user-defined control routine; and a task manager module for managing the task modules to be executed in a predetermined order.

According to another aspect of the present invention, there is provided a data acquisition method for process control, the method comprising: (1) a user interface window providing step of providing a user interface window in response to a user's request; (2) an task module generating step of generating one or more task modules allocated to each measuring equipment in response to a user's request input through the user interface window; (3) an editing interface providing step of providing an editing interface window in response to a user's editing request; (4) a data recognizing step of identifying formats of data detected by the measuring equipments and automatically recognizing the data in response to a control command input through the editing interface window; (5) a control routine generating step of generating a user-defined control routine by using the automatically-recognized data; and (6) an output step of outputting result values generated through the user-defined control routine.

According to still another aspect of the present invention, there is provided a recording medium on which a data acquisition program for process control is recorded, the data acquisition program executing: (a) a user interface window providing process of providing a user interface window in response to a user's request; (b) an task module generating process of generating one or more task modules allocated to each measuring equipment in response to a user's request input through the user interface window; (c) an editing interface providing process of providing an editing interface window in response to a user's editing request; (d) a data recognizing process of identifying formats of data detected by the measuring equipments and automatically recognizing the data in response to a control command input through the editing interface window; (e) a control routine generating process of generating a user-defined control routine by using the automatically-recognized data; and (f) an output process of outputting result values generated through the user-defined control routine.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a construction of a data acquisition system for process control according to the present invention;

FIG. 2 is a flowchart illustrating a data acquisition method for process control according to the present invention; and

FIGS. 3 to 14 are diagrams illustrating user interface screens according to the present invention.

### BEST MODE OF THE INVENTION

Now, the exemplary embodiments of the present invention will be described in detail with reference to the accompanying drawings.

First, the present invention provides a data acquisition method having characteristics of generality (applicability to any T & M instrument), openness (integration of user/vendor programs), extensible data packing, real-time controllability, intuitive property and flexibility of interfaces, and scalability.

That is, the generality is required for automatically recognizing and reading out formats and patterns of various data by equipments, and specifically, automatically recognizing and processing changes in format and pattern of data caused when equipment settings are dynamically changed.

The openness is required for absorbing and merging data of third party applications provided from vendors as well as any user-defined input such as feedback control into a process being currently executed, to perform synthetic feedback control.

The extensible data packing is required for synchronizing serialized (that is, parallel-in/serial-out) data packets by adding headers by sources to individual data obtained from data sources of which a data type or a sampling rate is different from each other, and when the data packets are received, supporting a function (that is, a function of processing a serial-in/parallel-out process) of decomposing the data packets into constituent elements on the basis of information included in the headers.

The real-time controllability is required for supporting a cross-reference function of not only allowing global control parameters to be passively controlled by a user and also to be controlled by user-defined programs, but also allowing the global control parameters to be mutually controlled in a specific process and to be mutually controlled between the processes.

The intuitive property and flexibility of interfaces are required for providing interfaces which can be dynamically constructed in accordance with a user's plan. Structures of the interfaces are provided in a flowchart format most suitable for securing the flexibility, and the respective constituent elements having a graphical object type in the interfaces are connected with oriented links, so that a flexible construction of a flowchart, an execution order of the constituent elements, and mutual relations are intuitively expressed. The oriented links have single line arrows and the single line connections are by-products of the flexibility associated with a data merging process.

The scalability is required for not restricting the number of task modules and task manager modules which can be simultaneously executed. For example, in a case where two or more task modules are managed, that is, in a case where two or more processes are controlled, an interface for receiving a temporal execution order of the task modules in accordance with a user's plan is introduced. In a case where two or more task manager modules are provided, the restriction to the number of task manager modules is released by simultaneously executing executable files relating to the respective task manager modules. In this case, in order to remove unnecessary interference between the executable files, a solution to which the present invention is applied does not use a shared memory.

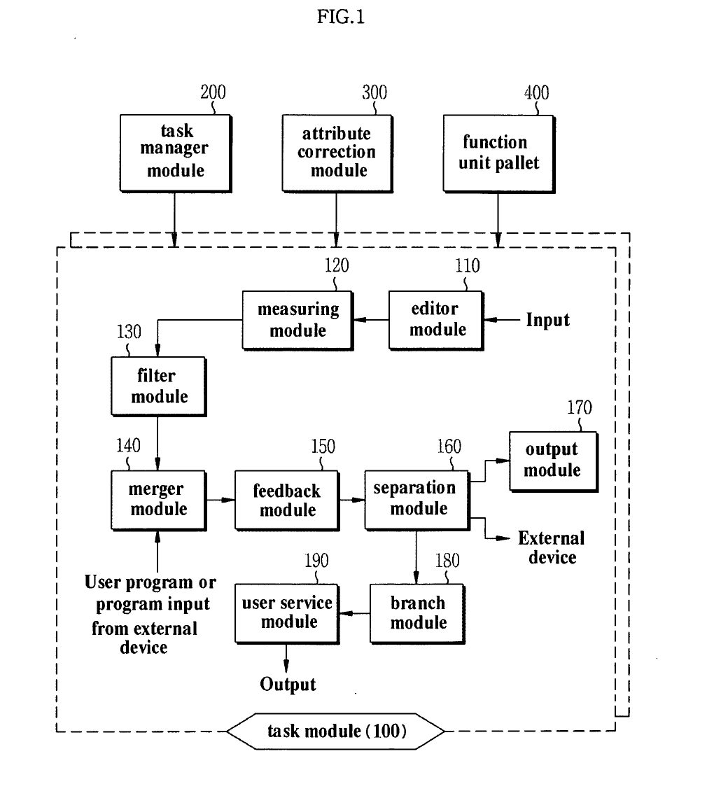

As shown in FIG. 1, the data acquisition method for process control according to the present invention maintains continuity of data streams, unlike a discontinuous data acquisition method such as a scan cycle method of periodically repeating a procedure of scanning all inputs in a bundle as a case of control of programmable logic controller (PLC), executing programs, and updating all outputs in a bundle. That is, the task manager module takes charge of batch processes of actions, that is, operations such as task modules, and the respective task modules can completely prevent data loss through connection lines between function units to acquire data continuously.

That is, according to the present invention, it is possible to monitor a continuous flow of data and sequentially control discontinuous operations through batch control, by simultaneously supporting continuous processes and batch processes which are two exclusive concepts.

Now, constructions and operation of the present invention having the aforementioned features will be described in detail.

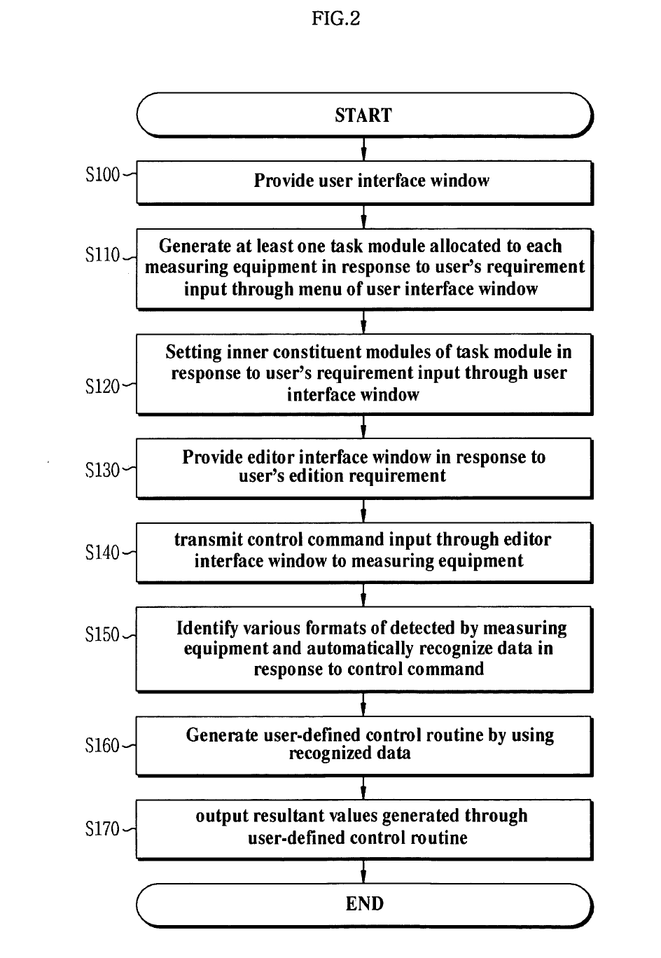

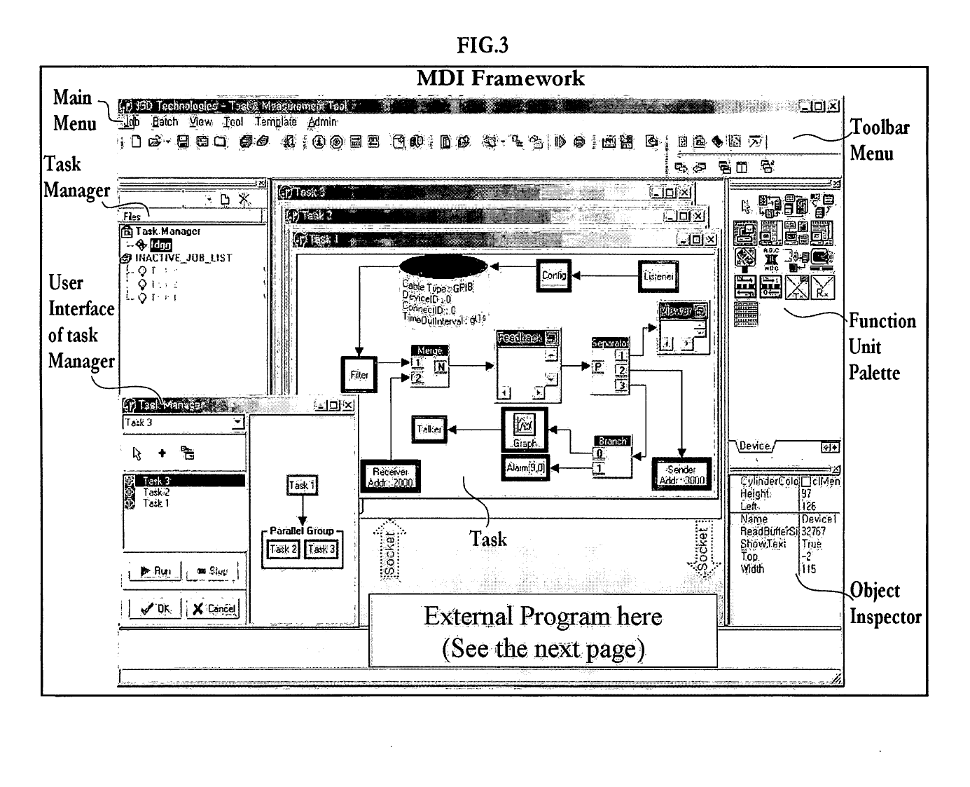

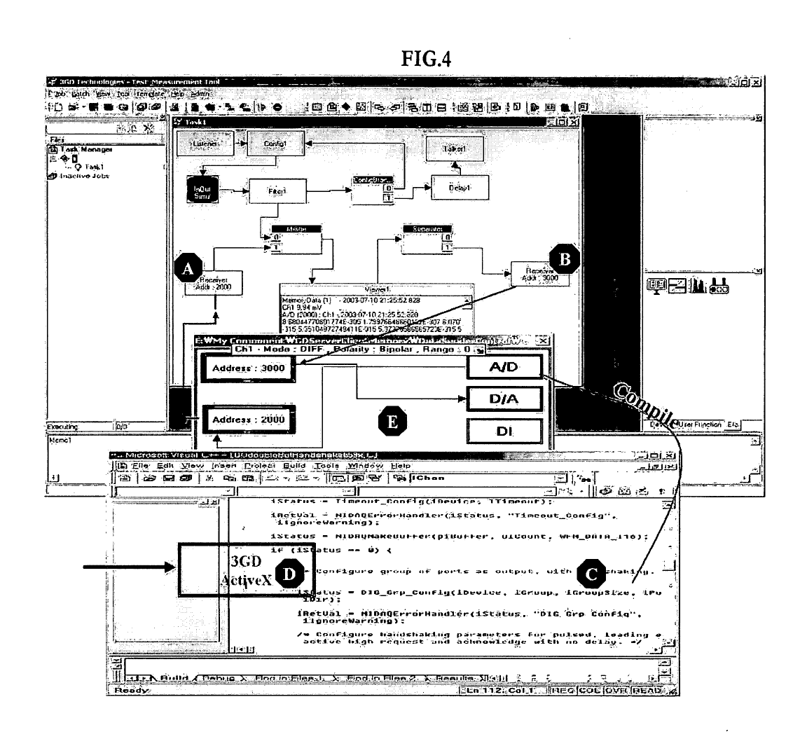

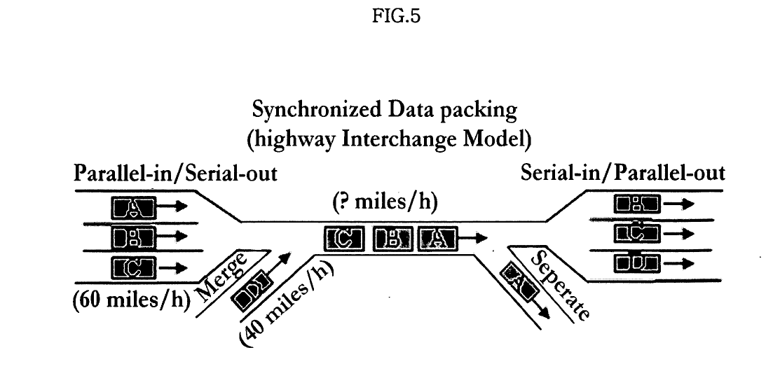

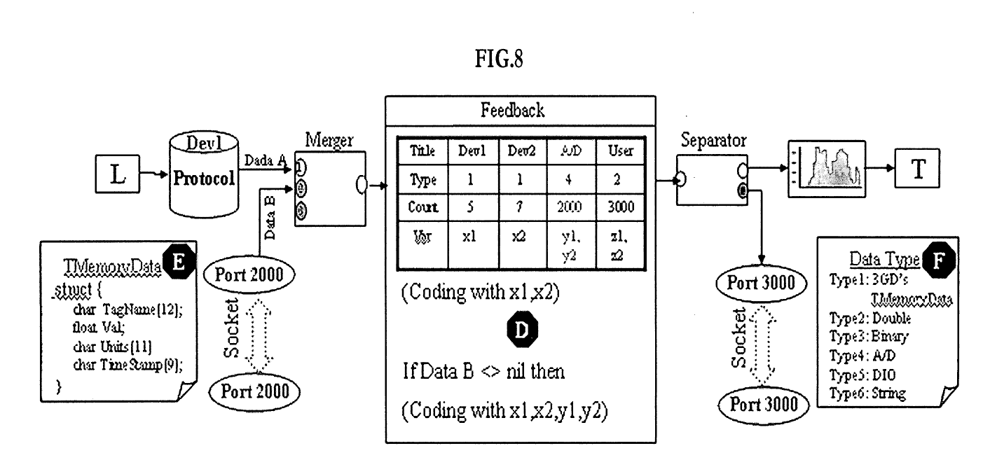

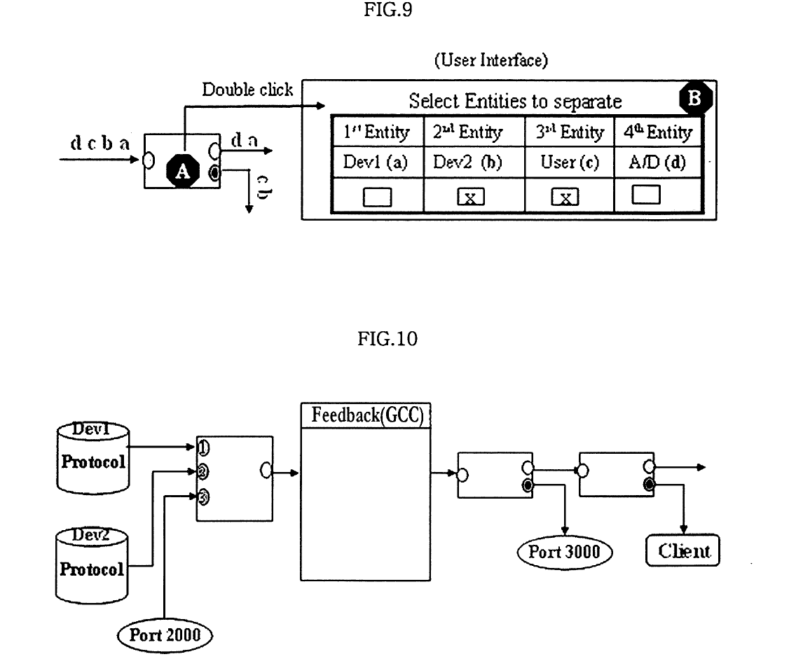

FIG. 1 is a block diagram illustrating a construction of a data acquisition system for process control according to the present invention, FIG. 2 is a flowchart illustrating a data acquisition method for process control according to the present invention, and FIGS. 3 to 14 are diagrams illustrating user interface screens generated according to the present invention.

As shown in FIG. 1, the data acquisition system for process control according to the present invention approximately comprises a task module 100 including at least one modules, a task manager module 200 for managing the task modules to be executed in a predetermined order, an attribute correction module 300 for correcting attributes of the modules included in the task module 100 in accordance with intention of a user, and a function unit pallet 400 having 21 function units.

Specifically, the task module 100 comprises an editor module 110 for transmitting a control command which is set by a user and is input to each measuring equipment in accordance with a communication protocol, a measuring module 120 for storing the communication protocol, a filter module 130 for identifying various formats of data detected by the measuring equipments and automatically recognizing the data in response to the control command transmitted in accordance with the communication protocol stored in the measuring module 120, a merger module 140 for receiving user programs or programs supplied from external devices, allowing the programs to be absorbed and merged into the data supplied from the filter module 130 and outputting the merged data, a feedback module 150 for generating a user-defined control routine and generating user-defined data by using the recognized data, a separation module 160 for separating the data supplied from the control routine of the feedback module 150 and outputting the separated data to the external devices, a branch module 180 for processing conditional statements or loop statements, a user service module 190 for displaying the data output from the branch module 180 in a graph type and giving an alarm when the data departs from a predetermined reference range, and an output module 170 for outputting and monitoring the data stored temporarily in the respective modules.

Here, a reception module for receiving the user programs or the programs input from the external devices may be separately provided at a front stage of the merger module 140, and a transmission module for outputting resultant values of separation of the separation module 160 to the external devices may be separately provided at a rear stage of the separation module 160.

The editor module 110, the feedback module 150, and the branch module 180 generate dynamically control parameters which can be called out in real time for a cross-reference between processes, and generates interfaces of the control parameters, to provide the interfaces of the control parameters.

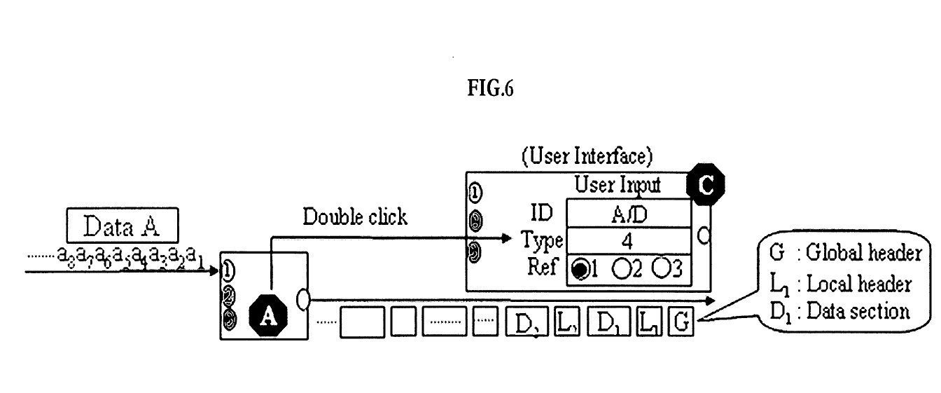

As shown in FIG. 6, the merger module 140 synthesizes data streams different each other in kind to be input, by repeatedly performing a procedure of: checking whether data streams different in sampling rate are input, generating a global header G when the data streams different in sampling rate are input, generating a first local header L1 representing a previously-arrived data stream, positioning the first local header L1 at the rear end of the global header G, positioning a first data D1 at the rear end of the first local header L1, checking whether a next input data is the same kind of data as the first data, positioning a second data (being absorbed into D1 because the second data has the same type as D1) at the rear end of the first local header L1 without generating another local header when the next input data is the same kind of data, checking whether another next input data is the same kind of data as the first and second data, generating and positioning a second local header L2 when the another next input data is a different kind of data, positioning a third data at the rear end of the second local header L2, and checking another next input data. At this time, since the second data D1 has the same type as the first data D1, the second data D1 is absorbed by the first data.

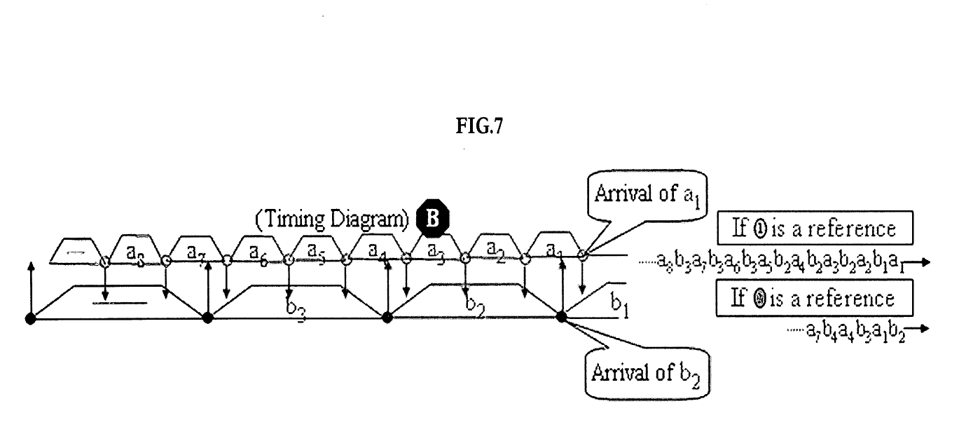

That is, as shown in FIG. 7, when two data a, b having different sampling rates are input to the merger module 140 from two different equipments, the merger module 140 synchronizes the two data using the data a having a smaller sampling rate as a reference, or synchronizes the two data using the data b having a larger sampling rate as a reference.

The method of synchronizing the two data using the data a having a smaller sampling rate as a reference will be first described.

The merger module 140 checks whether data a1 is recognized, records a1 when the data a1 is recognized, and then checks whether data input at the beginning point of a1 is recognized. When data b1 is recognized, the merger module 140 records the data b1 after the data a1.

Then, the merger module 140 checks whether data a2 is recognized, records the data a2 after the data b1 when the data a2 is recognized, and checks whether data input at the beginning point of a2 is recognized. When data b2 is recognized, the merger module 140 records the data b2 after the data a2.

Then, the merger module 140 checks whether data a3 is recognized, records the data a3 after the data b2 when the data a3 is recognized, and checks whether data input at the beginning point of a3 is recognized. When data b2 is recognized, the merger module 140 records the data b2 after the data a3.

In this way, the merger module 140 synchronizes the two data.

Next, the method of synchronizing the two data using the data b having a larger sampling rate as a reference will be described.

The merger module 140 checks whether data b2 is recognized, records b2 when the data b2 is recognized, and then checks whether data input at the beginning point of b2 is recognized. When data a1 is recognized, the merger module 140 records the data a1 after the data b2.

Then, the merger module 140 checks whether data b3 is recognized, records the data b3 after the data a1 when the data b3 is recognized, and checks whether data input at the beginning point of b3 is recognized. When data a4 is recognized, the merger module 140 records the data a4 after the data b3.

Then, the merger module 140 checks whether data b4 is recognized, records the data b4 after the data a4 when the data b4 is recognized, and checks whether data input at the beginning point of b4 is recognized. When data a7 is recognized, the merger module 140 records the data a7 after the data b4.

When the two data are synchronized in this way, a2, a3, a5, and a6 of the data a are lost. Therefore, when data are received from two equipments, the synchronization should be performed by using data having a smaller sampling rate as a reference data.

The global control parameters generated by the feedback module 150 is duplicated in accordance with intention of the user, is used in another module in the same task module 100 or another task module 100, and is synchronized in connection with the task manager module 200 when values of the global control parameters are changed.

The user service module 190 includes a plotting service, a reporting service, client/server, and an analysis function.

On the other hand, an input terminal connected to the editor module 110 functions as sequentially executing the processes in accordance with a synchronization manner, when relative temporal positions of the respective task modules 100 in the task manager module 200 are dynamically changed in real time, and an output terminal connected to the user service module 190 notifies completion of a process to a sequence chart of the task manager module 200 when the process is completed.

The task manager module 200 supports that a procedure of controlling the individual constituent processes to be sequentially synchronized after a user records the individual constituent processes in the sequence chart can be implemented through graphical user interfaces (GUI) and inter-process communications (IPC), and also supports that a mutual control function can be implemented through the mutual call-out between the global control parameters dynamically generated by the respective processes. That is, the processes can have the mutual control function through cross-reference of the global control parameters.

The procedure of controlling the synchronized processes by the task manager module 200 will be described.

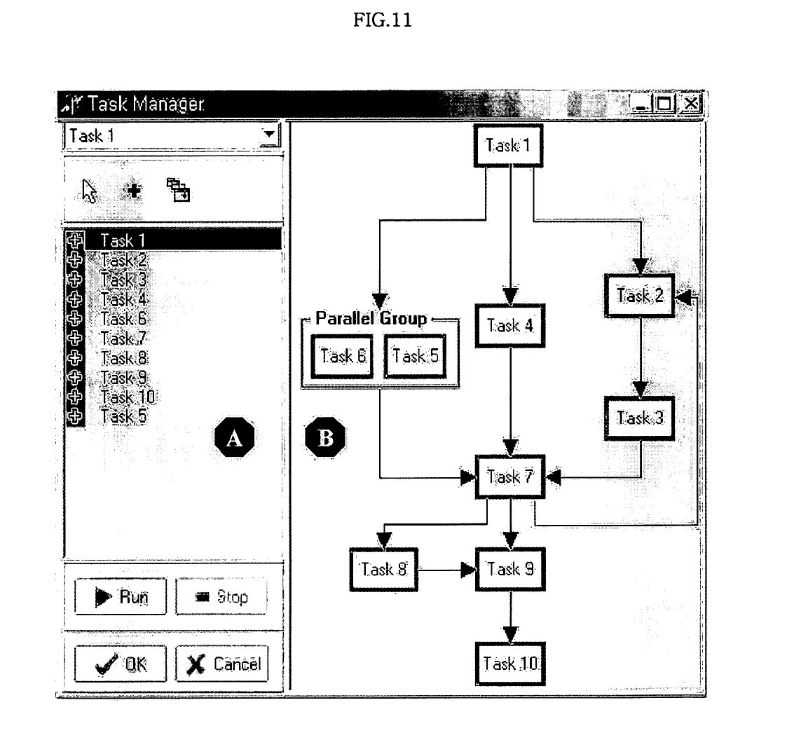

FIG. 11 shows a state where the individual task modules are recorded in the task manager module 200. Here, the user interface for receiving information on the sequential control system from the user is constructed by generating task modules of a desired type in a drag-and-drop manner and connecting them with lines.

A data acquisition method of the data acquisition system for process control will be described with reference to FIGS. 2 to 14.

First, when a user allows the program to be executed and then selects a RUN command, the data acquisition system provides a user interface window (S100) and creates at least one task module 100 allocated to each measuring equipment in response to the user's requirement input through a menu of the user interface window (S110). Then, the user drags and drops function units provided through the function unit pallet 400 to set the inside of the task module 100(S120).

The editor module 100 inputs a control command to an editor interface window in response to an editing requirement of the user (S130). Then, the editor module 100 transmits the control command input through the editor interface window to the measuring equipments (S140).

On the other hand, the filter module 130 receives the control command input through the editor interface window in accordance with a communication protocol of the measuring module 120, identifies various formats of data detected by the measuring equipments, and recognizes the data automatically (S150).

Then, the feedback module 150 generates a user-defined control routine by using the data automatically recognized by the filter module 130. The feedback module 150 also outputs the resultant values generated by means of the user-defined control routine to the output module 170, and also outputs the resultant values through the branch module 180 to the user service module 190 (S170).

Here, the feedback module 150 switches inputs such as a feedback routine by the user into a dynamic link library (DLL) and absorbs and merges the inputs into a part of the whole structure. That is, the feedback module 150 dynamically generates the global control parameters required for controlling the processes in real time, and provides the global control parameters in the GUI format to the user. The global control parameters can be shared by different task modules 100.

If the global control parameters shared by predetermined task modules are changed, the task manager module 200 performs a synchronization procedure that the global control parameters are similarly changed in different task modules, thereby implementing the cross-reference function.

At this time, if the same global control parameter is used twice or more in the same task module and one value of the global control parameter is changed, the other values of the global control parameter are changed into the same value through the synchronization procedure by the task manager module 200.

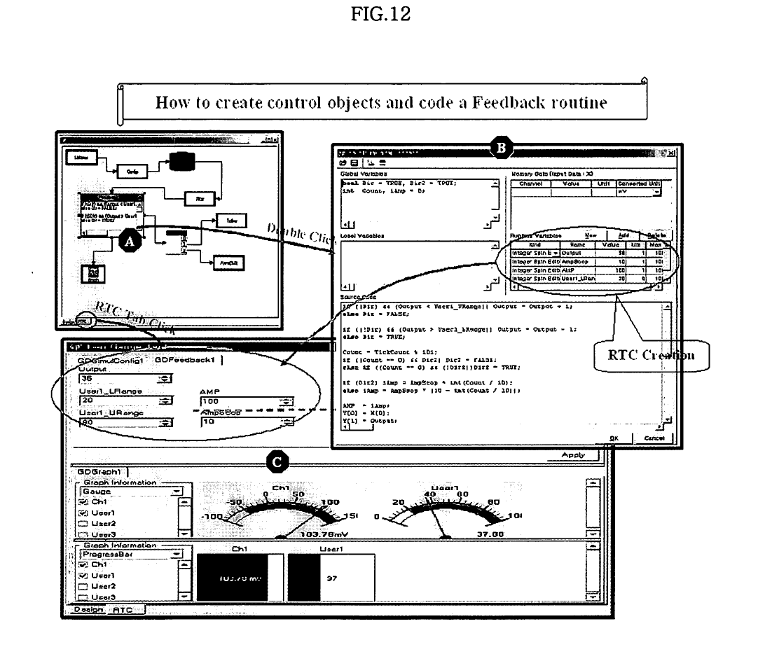

The feedback module 150 will be described in more detail with reference to FIGS. 12 to 14. As shown in FIG. 12, the global control parameters are generated dynamically in the task module 100. That is, a feedback editor window B is opened by double-clicking an icon A of the feedback module 150 in the task module 100, and necessary global control parameters and objects (or commands) for controlling the global control parameters in real time can be generated in the feedback editor window. The objects constitute another window C together with various kinds of graphs, thereby providing a final user interface of the whole task module.

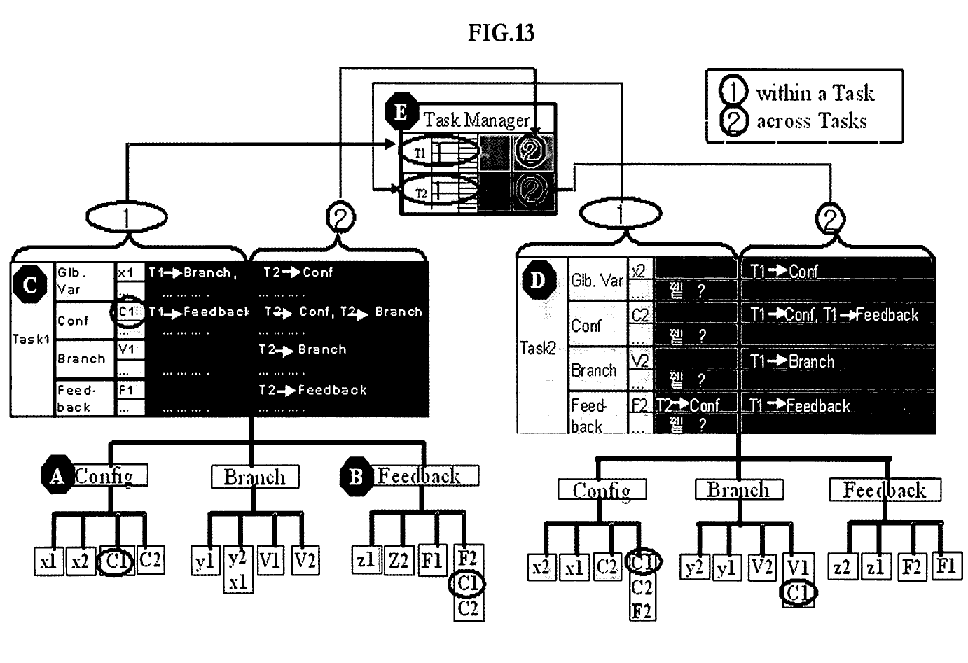

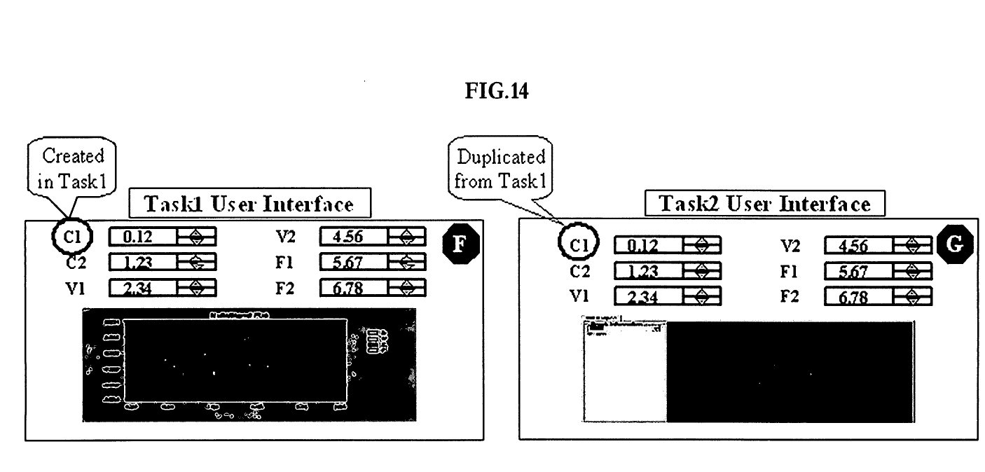

On the other hand, FIGS. 13 and 14 are diagrams illustrating a procedure in which the global control parameters pass through boundaries of the processes (that is, tasks) and are connected mutually in the hierarchical structure. The global control parameter C1 generated in an editor module A of a first task module can be duplicated for use in another function unit (feedback module B) of the first task module or in a second task module Task 2. The global control parameter C1 is connected and synchronized mutually through special managers C and D and a task manager module E for managing the global control parameters in the task modules. The global control parameters are provided through the final user interfaces F, G of the overall task modules.

On the other hand, when the feedback module 150 generates the user-defined control routine through the control routine generating step (S160), the feedback module 150 may generate the user-defined control routine by merging the user programs input through the merger module 140 or the programs supplied from external devices in addition to the automatically recognized data output from the filter module 130.

In this way, when the programs input through the merger module 140 are merged, the separation module 160 is provided at the rear stage of the feedback module 150. The separation module 160 separates the user data or the data supplied from the external devices absorbed and merged through the merger module 140 from the user-defined control routine generated through the control routine generating step (S160), and then transmits the data externally.

On the other hand, when the resultant values generated in accordance with the user-defined control routine generated through the control routine generating step (S160) are output (S170), the user service module 190 displays present states of the resultant values output through the separation module 160 and the branch module 180 in a graph format, and gives an alarm to the user when the resultant values depart from a predetermined reference range.

As a result, first, the present invention has an advantage that the development time can be shortened ten times or more, compared with the conventional systems developed mainly concentrated on the programming tools, so that it is possible to realize more efficient design and development. Developments having required several months can be substantially completed within a day, a half day, or several hours.

Second, the present invention has an advantage that ability capable of understanding and reusing a system can be improved extremely.

Third, the present invention has an advantage that since a filtering algorithm applicable to any measuring equipment or mechanical equipment is provided, additional user burden or cost for development relating to data format cannot be required.

Fourth, the present invention has an advantage that since a total solution is provided, all market areas can be unified completely.

Fifth, the present invention has an advantage that user's external programs can be connected to software including an event handler, a trigger, etc. through DLL, COM, socket, etc.

Sixth, the present invention has an advantage that a smart task manager module for synchronizing all corresponding operations while maintaining relative time difference between processes can allow any complex process to be controlled.

Specifically, the present invention gives support to arranging and analyzing data measured through measuring equipments by applying a customer relationship management (CRM) method, which represents methodology or software required for a company's managing customer relationships, to the measuring equipments, and thus has an advantage that the analyzed data can be used as a milepost for a next generation technology.

The present invention is not limited to the aforementioned embodiments, but may be properly changed or modified by those skilled in the art without departing from the gist and spirit of the present invention readable from the appended claims.

1. A data acquisition system for process control, the system comprising:
one or more task modules comprising an editor module for transmitting a control command which is set by a user and is input to each measuring equipment in accordance with a communication protocol, a measuring module for storing the communication protocol, a filter module for identifying a format of data detected by the measuring equipments and automatically recognizing the data in response to the control command transmitted in accordance with the communication protocol stored in the measuring module, a feedback module for generating a user-defined control routine and generating user-defined data by using the recognized data, and a branch module for processing conditional statements or loop statements in response to the user-defined control routine; and
a task manager module for managing the task modules to be executed in a predetermined order.

2. The data acquisition system according to claim 1, further comprising:
an attribute correction module for correcting attributes of the modules included in the task modules in accordance with intention of a user; and
a function unit pallet having a plurality of function units.

3. The data acquisition system according to claim 1, wherein each task module further comprises:
a merger module for receiving a user program or a program supplied from external devices, allowing the program to be absorbed and merged into the data supplied from the filter module, and transmitting the merged data to the feedback module; and
a separation module for separating the data supplied from the control routine of the feedback module and outputting the separated data to the external devices.

4. The data acquisition system according to claim 1, wherein each task module further comprises:
a user service module for displaying the data output from the branch module in a graph type and giving an alarm when the data departs from a predetermined reference range; and
an output module for outputting and monitoring the data stored temporarily in the respective modules.

5. The data acquisition system according to claim 1, wherein the editor module, the feedback module and the branch module dynamically generate control parameters which can be called out in real time for a cross conference among the processes, and generate and supply interfaces of the control parameters to the user.

6. The data acquisition system according to claim 2, wherein the merger module merges different kinds of data streams, by repeating the following procedure:
checking whether a plurality of data streams having different sampling rates are input, generating a global header when the plurality of data streams are input, generating a first local header representing a previously-arrived data stream, positioning the first local header at the rear end of the global header, positioning a first data at the rear end of the first local header, checking whether next input data is the same kind of data as the first data, generating and positioning another local header when the next input data is the same kind of data, positioning a second data at the rear end of the another local header, checking whether another next input data is the same kind of data as the first and second data, generating and positioning a second local header when the another next input data is a different kind of data, positioning a third data at the rear end of the second local header, and checking another next input data.

7. The data acquisition system according to claim 1, wherein global control parameters generated by the feedback module is duplicated in accordance with intention of the user, is used in another module in the task module or another task module, and is synchronized in connection with the task manager module when values of the global control parameters are changed.

8. A data acquisition method for process control, the method comprising:
(1) a user interface window providing step of providing a user interface window in response to a user's request;
(2) an task module generating step of generating one or more task modules allocated to each measuring equipment in response to a user's request input through the user interface window;
(3) an editing interface providing step of providing an editing interface window in response to a user's editing request;
(4) a data recognizing step of identifying formats of data detected by the measuring equipments and automatically recognizing the data in response to a control command input through the editing interface window;
(5) a control routine generating step of generating a user-defined control routine by using the automatically-recognized data; and
(6) an output step of outputting result values generated through the user-defined control routine.

9. The data acquisition method according to claim 8, further comprising the steps of:
a merging step of receiving a user program or a program supplied from external devices, and merging the received program with the data recognized in the data recognizing step; and
a separation step of separating the user program or the program supplied from external devices absorbed and merged in the merging step from the user-defined control routine generated in the control routine generating step, and transmitting the separated program externally.

10. The data acquisition method according to claim 8, wherein the output step comprises a user service step of displaying a current state of the result data generated through the user-defined control routine in a graph type, and giving an alarm when the result data departs from a predetermined reference range.

11. The data acquisition method according to claim 8, wherein the control routine generating step comprises a step of dynamically generating control parameters which can be called out in real time for a cross conference among the processes, and generating and supplying interfaces of the control parameters to the user.

12. The data acquisition method according to claim 8, wherein the merging step comprises a step of merging different kinds of data streams by repeating the following procedure:
checking whether a plurality of data streams having different sampling rates are input, generating a global header when the plurality of data streams are input, generating a first local header representing a previously-arrived data stream, positioning the first local header at the rear end of the global header, positioning a first data at the rear end of the first local header, checking whether next input data is the same kind of data as the first data, generating and positioning another local header when the next input data is the same kind of data, positioning a second data at the rear end of the another local header, checking whether another next input data is the same kind of data as the first and second data, generating and positioning a second local header when the another next input data is a different kind of data, positioning a third data at the rear end of the second local header, checking another next input data.

13. The data acquisition method according to claim 8, wherein the control routine generating step comprises a step of generating global control parameters, allowing the global control parameters to be duplicated in accordance with intention of the user and to be used in another module in the same task module or another task module, and synchronizing the global control parameters in connection with an task manager module when values of the global control parameters are changed.

14. A recording medium on which a data acquisition program for process control is recorded, the data acquisition program executing:
(a) a user interface window providing process of providing a user interface window in response to a user's request;
(b) an task module generating process of generating one or more task modules allocated to each measuring equipment in response to a user's request input through the user interface window;
(c) an editing interface providing process of providing an editing interface window in response to a user's editing request;
(d) a data recognizing process of identifying formats of data detected by the measuring equipments and automatically recognizing the data in response to a control command input through the editing interface window;
(e) a control routine generating process of generating a user-defined control routine by using the automatically-recognized data; and
(f) an output process of outputting result values generated through the user-defined control routine.

15. The recording medium according to claim 14, further comprising:
a merging process of receiving a user program or a program supplied from external devices, and merging the received program with the data recognized in the data recognizing process; and
a separation process of separating the user program or the program supplied from external devices absorbed and merged by a merger module from the user-defined control routine generated in the control routine generating process, and transmitting the separated program externally.

16. The recording medium according to claim 14, wherein the output process comprises a user service process of displaying a current state of the result data generated through the user-defined control routine in a graph type, and giving an alarm when the result data departs from a predetermined reference range.

17. The recording medium according to claim 14, wherein the control routine process comprising a process of dynamically generating control parameters which can be called out in real time for a cross conference among the processes, and generating and supplying interfaces of the control parameters to the user.

18. The recording medium according to claim 14, wherein the merging process comprises a process of merging different kinds of data streams by repeating the following procedure:
checking whether a plurality of data streams having different sampling rates are input, generating a global header when the plurality of data streams are input, generating a first local header representing a previously-arrived data stream, positioning the first local header at the rear end of the global header, positioning a first data at the rear end of the first local header, checking whether next input data is the same kind of data as the first data, generating and positioning another local header when the next input data is the same kind of data, positioning a second data at the rear end of the another local header, checking whether another next input data is the same kind of data as the first and second data, generating and positioning a second local header when the another next input data is a different kind of data, positioning a third data at the rear end of the second local header, and checking another next input data.

19. The recording medium according to claim 14, wherein the control routine generating process comprises a process of generating global control parameters, allowing the global control parameters to be duplicated in accordance with intention of the user and to be used in another module in the same task module or another task module, and synchronizing the global control parameters in connection with an task manager module when values of the global control parameters are changed.
